(19) United States
(12) Patent Application Publication
(10) Pub. No.: US 2022/0045571 A1
(43) Pub. Date: Feb. 10, 2022

(54) Ceiling fan motor

(71) Applicant: Lee Ming Chang, Taipei (TW)

(72) Inventor: Lee Ming Chang, Taipei (TW)

(21) Appl. No.: 16/987,411

(22) Filed: Aug. 7, 2020

(51) Int. Cl. H02K 3/52; F04D 25/08

(52) U.S. Cl. CPC H02K 3/522; H02K 2203/06; F04D 25/088

(57) ABSTRACT

A ceiling fan motor contains: a stator, at least one hook, and multiple coil winding sets, and an enameled wire connected with two coil winding sets and hooked by the at least one hook. The at least one hook is formed as a respective connection member of multiple connection members, and the multiple connection members are fixed in the stator.

### FIELD OF THE INVENTION

The present invention relates to a ceiling fan motor in which the two coil winding set, an electric wire, and the multiple connection members are weld automatically.

### BACKGROUND OF THE INVENTION

With reference to FIG. 7, a conventional ceiling fan motor 80 contains a stator 81. The stator 81 includes a tube 82 erected on a center of a top thereof, an aperture 83 defined on an outer wall of the tube 82 and communicating with a through orifice 84 of an inner wall of the tube 82, and multiple coil winding sets 85 winding around the tube 82 and an outer wall of the stator 81, wherein the multiple coil winding sets 85 define a respective enameled wire 86 of multiple enameled wires 86 and surround the stator 81, and two enameled wires 86 are winded and welded with an electric wire 87, wherein a free end of the electric wire 87 extends out of the tube 82 via the aperture 83 and the through hole 84.

After the conventional ceiling fan motor is electrified, the multiple coil winding sets 85 transform electricity into a magnetic effect so as to magnetically attract and repel and to drive a rotator (not shown) of the ceiling fan motor 80 to rotate with respect to the stator 81. Thus, the multiple enameled wires 86 are connected with the electric wire 87 so as to ensure normal operation of the ceiling fan motor 80.

A respective enameled wire 86 is made of metal and is covered by a non-conductive coating film. In assembly of the conventional ceiling fab motor, the non-conductive coating film is removed from the respective enameled wire 86, and two end of the two enameled wires 86 are winded and welded with the electric wire 87, and a plastic sleeve 88 is fitted onto the two enameled wires 86 and the electric wire 86. Thereafter, at least one fixing bend 89 is tied on the plastic sleeve 88. According, the conventional ceiling fan motor is connected troublesomely and manually.

The present invention has arisen to mitigate and/or obviate the afore-described disadvantages.

### SUMMARY OF THE INVENTION

The primary aspect of the present invention is to provide a ceiling fan motor in which the two coil winding set, an electric wire, and the multiple connection members are weld automatically.

To achieve above-mentioned aspect, a ceiling fan motor provided by the present invention contains: a stator, at least one hook, and multiple coil winding sets, and an enameled wire connected with two coil winding sets and hooked by the at least one hook.

The at least one hook is formed as a respective connection member of multiple connection members, and the multiple connection members are fixed in the stator.

In another embodiment, a tube is erected on a top of the stator, and the respective connection member includes a horizontal portion, wherein the horizontal portion has an internal face connected with the tube, and the horizontal portion has an external face and the at least one hook extending from the external face.

In another embodiment, the stator includes a fixer, and the fixer has at least one receiving hole, wherein the respective connection member includes a vertical portion, a horizontal portion extending from a side of the vertical portion, and the at least one hooks extending from a side of the horizontal portion, wherein an end of the vertical portion is inserted into a respective receiving hole, the horizontal portion and the at least one hook are spaced a distance from the fixer.

In another embodiment, the stator includes a positioning block, and the positioning block has at least one receiving hole; the respective connection member includes a vertical portion, wherein the vertical portion has the at least one hook extending from a first end thereof, and a second end of the vertical portion is inserted into a respective receiving hole of multiple receiving hole of a positioning block.

### BRIEF DESCRIPTION OF THE DRAWINGS

FIG. 1 is a perspective view showing the assembly of a part of a ceiling fan motor according to a first embodiment of the present invention.

FIG. 2 is a perspective view showing the assembly of another part of the ceiling fan motor according to the first preferred embodiment of the present invention.

FIG. 3 is a side plan view showing the assembly of another part of the ceiling fan motor according to the first preferred embodiment of the present invention.

FIG. 4 is a perspective view showing the assembly of a part of a ceiling fan motor according to a second embodiment of the present invention.

FIG. 5 is a perspective view showing the assembly of a part of a ceiling fan motor according to a third embodiment of the present invention.

FIG. 6 is a perspective view showing the assembly of a part of a ceiling fan motor according to a fourth embodiment of the present invention.

FIG. 7 is a perspective view of a conventional ceiling fan motor.

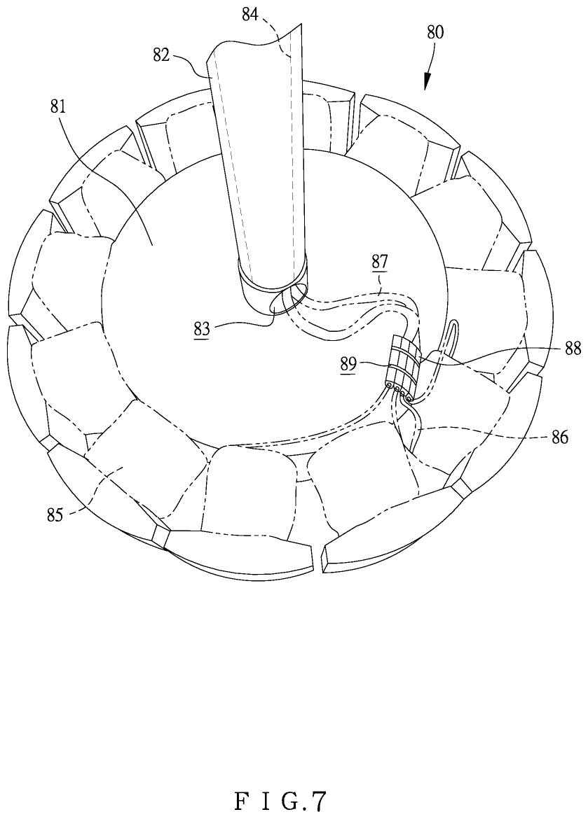

### DETAILED DESCRIPTION OF THE PREFERRED EMBODIMENTS

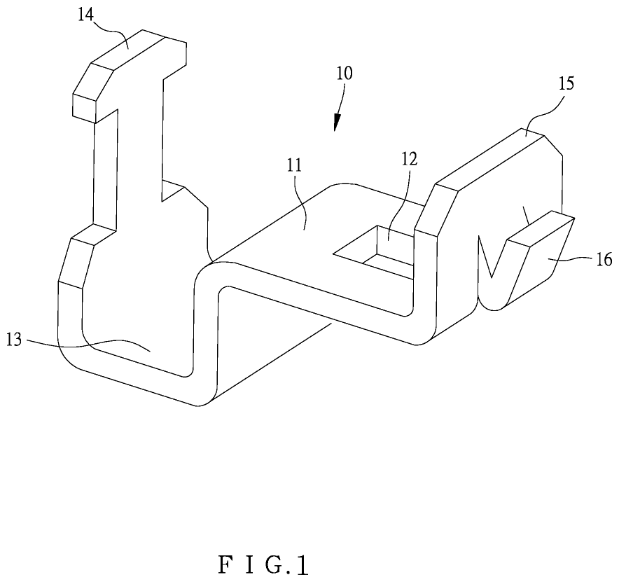

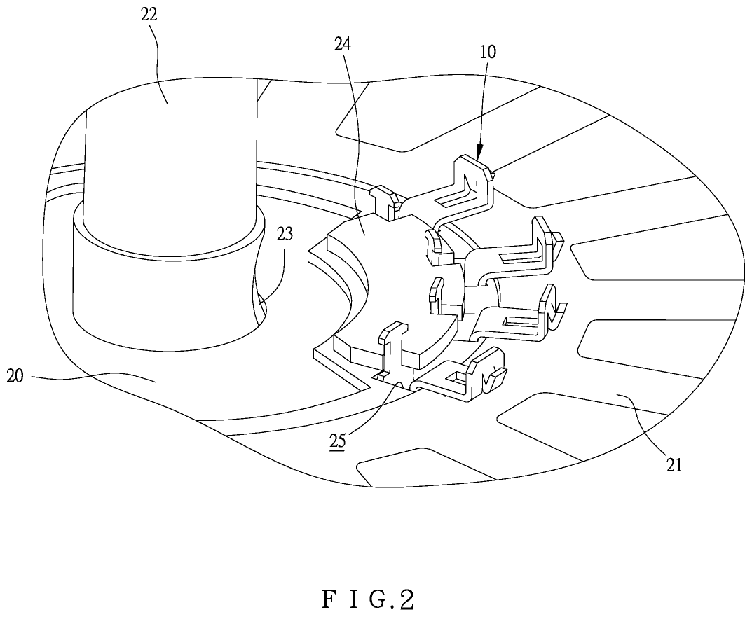

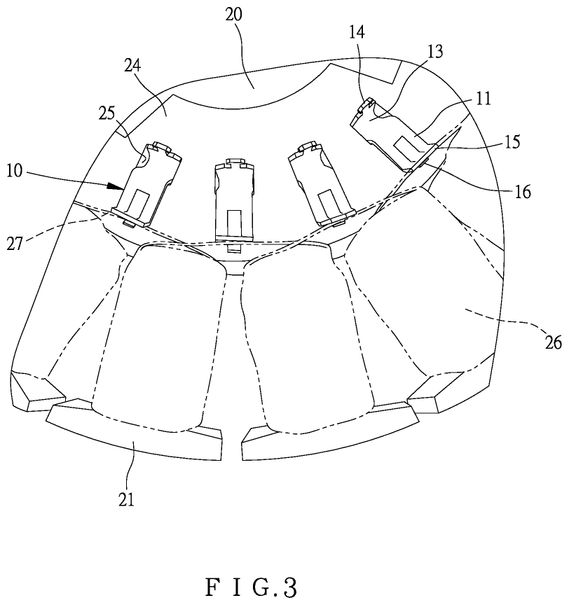

With reference to FIGS. 1-3, a ceiling fan motor according to a first embodiment of the present invention comprises: a stator 20, multiple extensions 21 radially extending around the stator 20, multiple coil winding sets 26 winding around the multiple extensions 21, a tube 22 erected on a center of a top of the stator 20, an elongated orifice 23 defined on an outer wall of a lower end of the tube 22, a protrusion 24 mounted on the top of the stator 20, and multiple receiving holes 25 formed on the protrusion 24.

Multiple connection members 10 are connected on the top of the stator 20 adjacent to the multiple receiving holes 25, and a respective connection member 10 includes a horizontal portion 11, a vertical portion 15 vertically extending upward from a first end of the horizontal portion 11, an U-shaped bending portion 13 extending from a second end of the horizontal portion 11, a perpendicular portion 14 extending upward from an end of the U-shaped bending portion 13 away from horizontal portion 11 and parallel to the vertical portion 15, wherein the perpendicular portion 14 and the vertical portion 15 vertically bend from two sides of the respective connection member 10. The respective connection member 10 further includes a hook 16 extending from the vertical portion 15 away from the perpendicular portion 14, and the respective connection member 10 includes an L-shaped trench 12 defined on the horizontal portion 11 and the vertical portion 15 proximate to the hook 16.

When the U-shaped bending portion 13 is accommodated in a respective receiving hole 25, the respective connection member 10 is fixed in the stator 20, the U-shaped bending portion 13 supports the horizontal portion 11 to be fixed outside the protrusion 24 so that the perpendicular portion 14 extends out of the respective receiving hole 25, and an enameled wire 27 connected with two coil winding sets 26 is hooked by the hook 16.

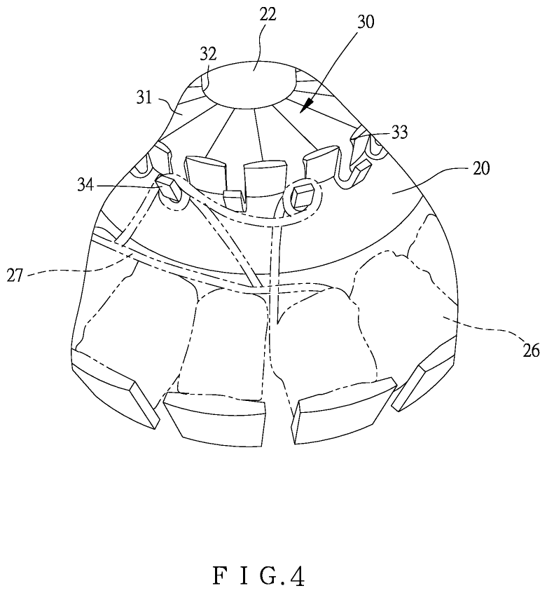

Referring to FIG. 4, a different of a ceiling fan motor of a second embodiment from that of the first embodiment comprises: multiple connection members 30, and a respective connection member 30 does not include the vertical portion 15, the L-shaped trench 12, the U-shaped bending portion 13, and the perpendicular portion 14 of the first embodiment.

In other words, the ceiling fan motor comprises the horizontal portion 31, and the horizontal portion 31 has an internal face 32 connected with the tube 22 so that the respective connection member 30 is fixed in the stator 20. The horizontal portion 31 has an external face 33 and a hook 34 extending from the external face 31 and configured to hook the enameled wire 27 of the two coil winding sets 26.

The horizontal portion 31 is formed in an isosceles triangle shape, wherein multiple horizontal portions 31 of the multiple connection members 30 are connected in a circle shape.

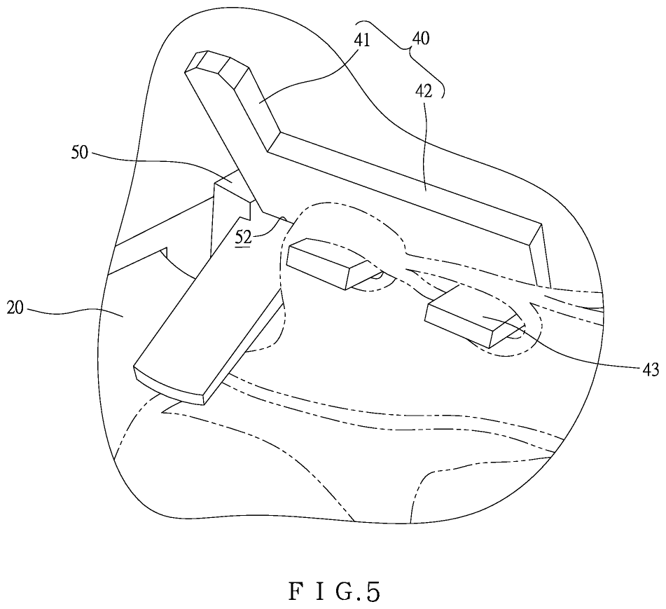

As shown in FIG. 5, a different of a ceiling fan motor of a third embodiment from that of the first embodiment comprises: multiple connection members 40, and a respective connection member 40 does not include the L-shaped trench 12, the U-shaped bending portion 13, and the perpendicular portion 14 of the first embodiment.

For example, the stator 20 includes a fixer 50, and the fixer 50 has at least one receiving hole 52, wherein the respective connection member 40 is formed in a T shape, and the respective connection member 40 includes a vertical portion 41, a horizontal portion 42 extending from a side of the vertical portion 41, and two hooks 42 extending from a side of the horizontal portion 42.

An end of the vertical portion 41 is inserted into a respective receiving hole 52, the horizontal portion 42 and the two hooks 43 are spaced a distance from the fixer 50, and the two hooks 43 hook the two coil winding sets 26.

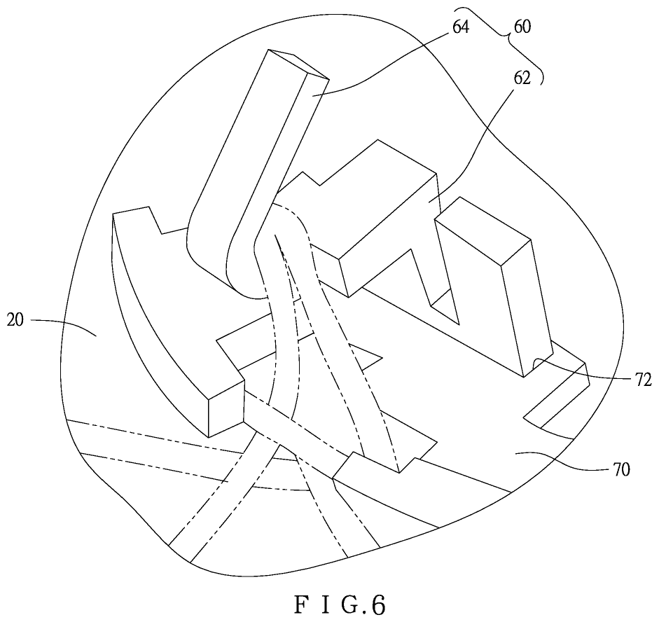

As illustrated in FIG. 6, a different of a ceiling fan motor of a fourth embodiment from that of the first embodiment comprises: multiple connection members 60, and a respective connection member 60 does not include the horizontal portion 11, the L-shaped trench 12, and the perpendicular portion 14 of the first embodiment.

The vertical portion 62 includes a hook 64 extending from a first end thereof, and a second end of the vertical portion 62 is inserted into a respective receiving hole 72 of a positioning block 70. The positioning block 70 is fixed in the stator 20, and a connection member 60 is fixed in the stator 20 to support the hook 64 to hook the two coil winding sets 64.

Thereby, the two coil winding set, an electric wire (not shown), and the multiple connection members of the ceiling fan motor are weld automatically.

While the preferred embodiments of the invention have been set forth for the purpose of disclosure, modifications of the disclosed embodiments of the invention and other embodiments thereof may occur to those skilled in the art. Accordingly, the appended claims are intended to cover all embodiments which do not depart from the spirit and scope of the invention.

What is claimed is:

1. A ceiling fan motor comprising: a stator, at least one hook, and multiple coil winding sets, and an enameled wire connected with two coil winding sets and hooked by the at least one hook.

2. The ceiling fan motor as claimed in claim 1, wherein the at least one hook is formed as a respective connection member of multiple connection members, and the multiple connection members are fixed in the stator.

3. The ceiling fan motor as claimed in claim 2, wherein the stator includes a protrusion on which multiple receiving holes are formed, the respective connection member includes a horizontal portion, a vertical portion vertically extending upward from a first end of the horizontal portion, an U-shaped bending portion extending from a second end of the horizontal portion and inserted into a respective receiving hole, and the U-shaped bending portion supports the horizontal portion to be fixed outside the protrusion.

4. The ceiling fan motor as claimed in claim 3, wherein a perpendicular portion extends upward from an end of the U-shaped bending portion away from horizontal portion and parallel to the vertical portion, and the perpendicular portion extends out of the respective receiving hole.

5. The ceiling fan motor as claimed in claim 2, wherein a tube is erected on a center of a top of the stator, and the respective connection member includes a horizontal portion, wherein the horizontal portion has an internal face connected with the tube, and the horizontal portion has an external face and the at least one hook extending from the external face.

6. The ceiling fan motor as claimed in claim 2, wherein the stator includes a fixer, and the fixer has at least one receiving hole, wherein the respective connection member includes a vertical portion, a horizontal portion extending from a side of the vertical portion, and the at least one hooks extending from a side of the horizontal portion, wherein an end of the vertical portion is inserted into a respective receiving hole, the horizontal portion and the at least one hook are spaced a distance from the fixer.

7. The ceiling fan motor as claimed in claim 2, wherein the stator includes a positioning block, and the positioning block has at least one receiving hole; the respective connection member includes a vertical portion, wherein the vertical portion has the at least one hook extending from a first end thereof, and a second end of the vertical portion is inserted into a respective receiving hole of multiple receiving hole of a positioning block.
